(19) United States
(12) Patent Application Publication
(10) Pub. No.: US 2021/0284138 A1
(43) Pub. Date: Sep. 16, 2021

(54) PARKING ASSISTANCE SYSTEM

(71) Applicant: HONDA MOTOR CO., LTD., Tokyo (JP)

(72) Inventors: Naoya Sakakibara, Wako-shi (JP); Hironobu Taniguchi, Wako-shi (JP)

(73) Assignee: HONDA MOTOR CO., LTD., Tokyo (JP)

(21) Appl. No.: 17/197,364

(22) Filed: Mar. 10, 2021

(30) Foreign Application Priority Data
Mar. 16, 2020 (JP) 2020-045868

(51) Int. Cl. B60W 30/06; B62D 15/02; G08G 1/14

(52) U.S. Cl. CPC B60W 30/06; H04W 4/40; G08G 1/141; B62D 15/021

(57) ABSTRACT

A relative velocity vector V is obtained which represents a time-dependent change of a relative position of a power receiving unit to a power transmitting unit set as a reference. Whether a user of a vehicle intends to park the vehicle into a parking space is determined depending on whether a relative velocity vector V(δ) after having been corrected in accordance with a steering angle δ of the vehicle is oriented toward the parking space. Parking assistance information is displayed on an image display device in accordance with an estimation result that the user of the vehicle intends to park the vehicle into the parking space.

### CROSS REFERENCES TO RELATED APPLICATIONS

The present application claims priority under 35 U.S.C. § 119 to Japanese Patent Application No. 2020-045868, filed Mar. 16, 2020, entitled “Parking Assistance System.” The contents of this application are incorporated herein by reference in their entirety.

### TECHNICAL FIELD

The present disclosure relates to a system for assisting parking of a vehicle in a situation of charging an on-board battery in a non-contact manner.

### BACKGROUND

Regarding a non-contact power feed system, there has been proposed a technique of selecting a power feed device (parking lot), which is to be used for feeding of electric power, from among searched power feed devices in accordance with a user's operation (such as selecting a vehicle that is a power feed target and instructing start of external charging) (see, for example, Japanese Patent No. 5910315).

Regarding an on-bard communication device, there has been proposed a technique of transmitting an inquiry signal for confirmation of reception to a plurality of power feed devices while reducing a magnitude of the inquiry signal step by step, and determining the specific power feed device (see, for example, Japanese Patent No. 5849876).

### SUMMARY

However, if the non-contact charging system and the vehicle are caused to automatically cooperate with each other and information for assisting parking is automatically displayed on an image display device mounted on the vehicle upon just approaching of the vehicle to a parking space, a user not intending to park the vehicle may feel annoyed by the displayed information.

In consideration of the above-described state of the art, it is desirable to provide a system that can improve the accuracy in estimating whether a user of a vehicle intends to park the vehicle, and that can reduce the annoyance felt by the user with display of parking assistance information.

A parking assistance system according to one aspect of the present disclosure includes a vehicle state recognition unit that recognizes a relative position of a power receiving unit mounted on a vehicle to a power transmitting unit that transmits electric power to the power receiving unit in a non-contact manner to charge a battery mounted on the vehicle, and a parking assistance unit that displays, on an image display device mounted on the vehicle, parking assistance information to assist parking of the vehicle in accordance with the relative position of the power receiving unit to the power transmitting unit, that relative position having been recognized by the vehicle state recognition unit, wherein the parking assistance unit includes a parking intention estimation unit that calculates a relative velocity vector representing a time-dependent change of the relative position having been recognized by the vehicle state recognition unit, and that estimates, based on a direction of the relative velocity vector, whether a user of the vehicle intends to park the vehicle into a parking space where the power transmitting unit is installed, and the parking assistance unit displays the parking assistance information on the image display device on condition of the parking intention estimation unit having determined that the user of the vehicle intends to park the vehicle.

According to the parking assistance system having the above-described feature, whether the user of the vehicle intends to park the vehicle into the parking space where the power transmitting unit is installed is determined based on the relative velocity vector representing the time-dependent change of the relative position of the power receiving unit or of the vehicle including the power receiving unit to the power transmitting unit set as a reference. The parking assistance information is displayed on the image display device in accordance with an estimation result that the user of the vehicle intends to park the vehicle into the parking space. On the other hand, the parking assistance information is not displayed on the image display device in accordance with an estimation result that the user of the vehicle does not intend to park the vehicle into the parking space. As a result, the accuracy in estimating the intention of the user to park the vehicle can be improved, and the user can be relieved from feeling annoyed by the parking assistance information that is selectively displayed or not on the image display device in accordance with the estimation result.

The expression of “recognizing” information is used herein as a concept including all types of arithmetic processes for processing the information into a state usable in a subsequent process and so on, such as receiving the information, reading the information from a storage device, searching the information from a database and so on, calculating, estimating, or determining the information based on the read information or the searched information, and storing the calculated or other information into the storage unit.

In the above-described parking assistance system, preferably, the parking intention estimation unit determines that the user of the vehicle intends to park the vehicle into the parking space, when the parking space where the power transmitting unit is installed is recognized and the relative velocity vector is oriented toward the parking space.

According to the parking assistance system having the above-described feature, when the relative velocity vector is oriented toward the parking space, it is estimated that the user intends to park the vehicle into the parking space. Then, the parking assistance information is displayed on the image display device in accordance with the above estimation result. On the other hand, when the relative velocity vector is not oriented toward the parking space, it is estimated that the user does not intend to park the vehicle into the parking space. Thus, the parking assistance information is not displayed on the image display device in accordance with the estimation result. As a result, the accuracy in estimating the intention of the user to park the vehicle can be improved, and the user can be relieved from feeling annoyed by the parking assistance information that is selectively displayed or not on the image display device in accordance with the estimation result.

In the above-described parking assistance system, preferably, the parking assistance unit calculates the relative velocity vector on condition that the relative position having been recognized by the vehicle state recognition unit falls within a range in which the power transmitting unit and the power receiving unit are detectable through wireless communication.

According to the parking assistance system having the above-described feature, whether the user of the vehicle intends to park the vehicle into the parking space where the power transmitting unit is installed is determined on condition that the power transmitting unit and the power receiving unit have come into a range in which both the units are detectable through wireless communication. It is inferred that the intention of the user to park the vehicle into the parking space or not is more clearly reflected on the relative velocity vector when the vehicle has come close to the parking space to such an extent that the power transmitting unit and the power receiving unit are positioned within the range in which both the units are detectable through wireless communication. Therefore, the accuracy in estimating whether the user intends to park the vehicle can be improved. Thus, the user can be relieved from feeling annoyed by the parking assistance information that is selectively displayed or not on the image display device in accordance with the estimation result.

In the above-described parking assistance system, preferably, the vehicle state recognition unit further recognizes a steering angle of the vehicle, and the parking intention estimation unit calculates the relative velocity vector based on, in addition to the relative position having been recognized by the vehicle state recognition unit, the steering angle of the vehicle.

According to the parking assistance system having the above-described feature, since it is inferred that the intention of the user to park the vehicle into the parking space or not is more clearly reflected on the steering angle of the vehicle, the accuracy in estimating whether the user intends to park the vehicle can be further improved. Thus, the user can be further relieved from feeling annoyed by the parking assistance information that is selectively displayed or not on the image display device in accordance with the estimation result.

### BRIEF DESCRIPTION OF THE DRAWINGS

The advantages of the disclosure will become apparent in the following description taken in conjunction with the following drawings.

FIG. 1 is an explanatory view related to a configuration of a parking assistance system according to an embodiment of the present disclosure.

FIG. 2 is an explanatory view related to functions of the parking assistance system according to the embodiment of the present disclosure.

FIG. 3 is an explanatory view related to a relative position of a power receiving unit to a power transmitting unit.

FIG. 4 is an explanatory view related to a relative velocity vector.

FIG. 5 is an explanatory view related to a display example of parking assistance information.

### DESCRIPTION OF THE PREFERRED EMBODIMENTS

### Configurations

### Configuration of Parking Assistance System

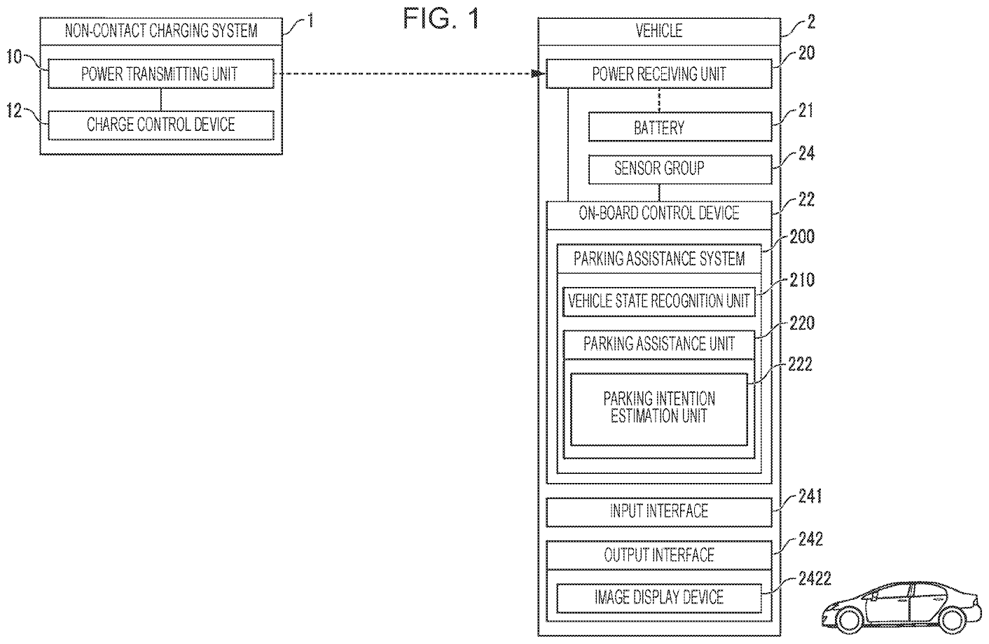

A parking assistance system 200 according to an embodiment of the present disclosure, illustrated in FIG. 1, is equipped on a vehicle 2. A non-contact charging system 1 for charging a battery 21, mounted on the vehicle 2, in a non-contact manner includes a power transmitting unit 10 and a charge control device 12. The non-contact charging system 1 has a two-way communication function with the vehicle 2.

For charging the battery 21 mounted on the vehicle 2, the power transmitting unit 10 transmits electric power to a power receiving unit 20, mounted on the vehicle 2, in a non-contact manner. The power transmitting unit 10 is installed in, for example, a parking space for the vehicle 2.

The charge control device 12 controls a power transmitting operation of the power transmitting unit 10. The charge control device 12 is constituted by an arithmetic processing unit (such as a CPU, a single-core processor, or a multi-core processor). The arithmetic processing unit reads necessary data and program (software) from a storage device (such as a HDD, a memory, or an SSD constituted by a memory) and executes arithmetic processing of the read data in accordance with the read program.

### Configuration of Vehicle

The vehicle 2 illustrated in FIG. 1 includes the power receiving unit 20, the battery 21, an on-board control device 22, a sensor group 24, an input interface 241, and an output interface 242.

For charging the battery 21, the power receiving unit 20 receives electric power from the power transmitting unit 10, installed in a designated place, in a non-contact manner. The battery 21 is constituted by, for example, a lithium-ion secondary battery. The on-board control device 22 controls operations of various components of the vehicle 2 as appropriate in accordance with output signals of various sensors constituting the sensor group 24.

The on-board control device 22 includes the parking assistance system 200. As in the charge control device 12, the on-board control device 22 is constituted by a storage device (such as a HDD, a memory, or an SSD constituted by a memory) and an arithmetic processing unit (such as a CPU, a single-core processor, or a multi-core processor) that reads necessary data and program (software) from the storage device and executes arithmetic processing of the read data in accordance with the read program. The input interface 241 is constituted by touch panel buttons and switches, a voice input device as required, and so on. The output interface 242 includes an image display device 2422 and a voice output device.

The parking assistance system 200 includes a vehicle state recognition unit 210 and a parking assistance unit 220. The vehicle state recognition unit 210 recognizes a vehicle state, such as a relative position of the power receiving unit 20 to the power transmitting unit 10, through communication with the vehicle 2 or the on-board control device 22 mounted on the vehicle 2. The parking assistance unit 220 includes a parking intention estimation unit 222. The parking intention estimation unit 222 estimates, based on the relative position and so on recognized by the vehicle state recognition unit 210, whether a user of the vehicle intends to park the vehicle. On condition of the parking intention estimation unit 222 estimating that the user intends to park the vehicle, the parking assistance unit 220 displays, on an image display device 2422 constituting the output interface 242 of the vehicle 2, parking assistance information that represents the relative position of the power receiving unit 20 to the power transmitting unit 10, that relative position having been recognized by the vehicle state recognition unit 210.

The parking assistance system 200, the vehicle state recognition unit 210, and the parking assistance unit 220, the latter two being components of the parking assistance system 200, are constituted by an arithmetic processing unit (such as a CPU, a single-core processor, or a multi-core processor). The arithmetic processing unit reads necessary data and program (software) from a storage device (such as a HDD, a memory, or an SSD constituted by a memory) and executes arithmetic processing of the read data in accordance with the read program.

Although the on-board control device 22, the input interface 241, and the output interface 242 may be constituted as on-board devices that are permanently mounted on the vehicle 2, they may be constituted by an information processing terminal, such as a smartphone or a tablet terminal, which is carried with a user and is temporarily mounted on the vehicle 2.

### Functions

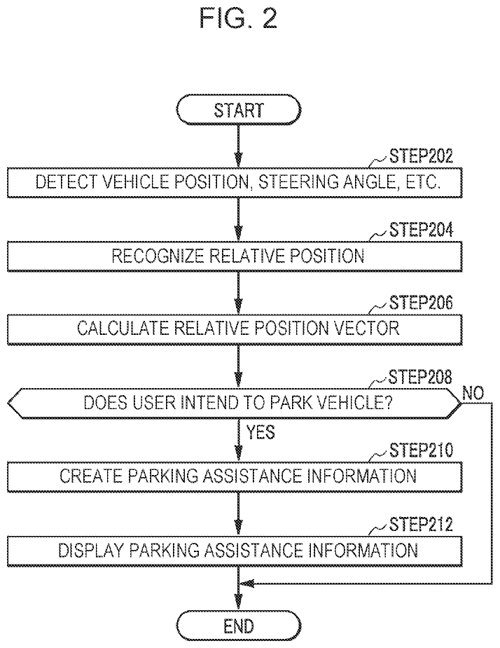

An example of the functions of the parking assistance system 200 having the above-described configuration will be described below with reference to a flowchart of FIG. 2. Those functions may be enabled after the vehicle 2 including the power receiving unit 20 has come close to the parking space where the power transmitting unit 10 is installed and communication between the non-contact charging system 1 and the vehicle 2 has been established.

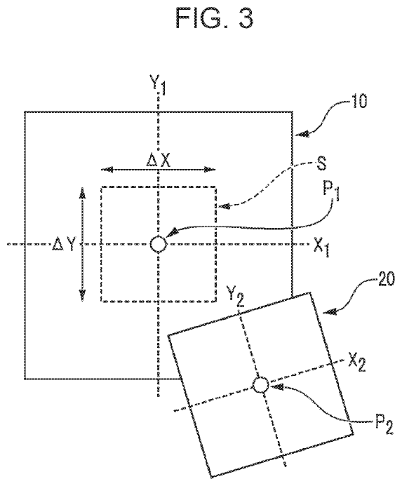

First, a position and a steering angle of the vehicle 2 are recognized by the vehicle state recognition unit 210 based on output signals from a positioning sensor and a steering angle sensor which constitute the sensor group 24 in the vehicle 2 (FIG. 2/STEP 202). The positioning sensor is constituted by, for example, GPS and an acceleration sensor if necessary. In such a case, coordinate values (defined by latitude and longitude) of the vehicle 2 in a world coordinate system are detected in accordance with a GPS signal (or a GPS signal and an acceleration signal). The positioning sensor may be constituted by an image pickup device (for example, a single-lens CCD camera or a multi-lens camera) and/or a ranging sensor (for example, a TOF sensor). In such a case, coordinate values of the vehicle 2 in a power-transmitting-unit coordinate system (X₁, Y₁) including an origin P₁, such as illustrated in FIG. 3, of which position and posture are fixed with respect to the power transmitting unit 10 may be detected based on an image that has taken by the image pickup device and that represents a state of the surroundings of the vehicle 2 including the power transmitting unit 10 and/or on a distance from the vehicle 2 to the power transmitting unit 10, the distance being measured by the ranging sensor.

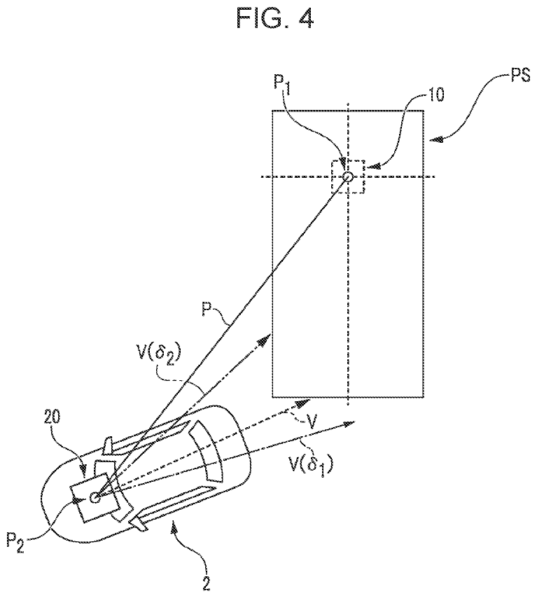

Furthermore, the vehicle state recognition unit 210 recognizes the relative position of the power receiving unit 20 to the power transmitting unit 10 based on the position of the vehicle 2, which has been detected as one of the vehicle states (FIG. 2/STEP 204). More specifically, the vehicle state recognition unit 210 reads a position P₁ (coordinate values in the world coordinate system) of the power transmitting unit 10, illustrated in FIG. 3, from a storage device in cooperation with the charge control device 12. Moreover, a position P₂ (coordinate values in the world coordinate system) of the power receiving unit 20, illustrated in FIG. 3, is obtained based on the position (coordinate values in the world coordinate system) of the vehicle 2, that position being detected as one of the vehicle states. Then, a deviation of the coordinate values of the power receiving unit 20 relative to the power transmitting unit 10 in the world coordinate system is determined as the relative position of the power receiving unit 20 to the power transmitting unit 10. When the detection result of the position of the vehicle 2 is expressed by the coordinate values in the power-transmitting-unit coordinate system (X₁, Y₁) illustrated in FIG. 3, the position P₂ of the power receiving unit 20 in the power-transmitting-unit coordinate system may be obtained from the above-mentioned detection result. Thus, a relative position vector P representing the position P₂ of the power receiving unit 20 with respect to the position P₁ of the power transmitting unit 10 is obtained as denoted by a solid-line arrow in FIG. 4.

The term “relative position” is used herein as a concept including a relative posture as well, namely a posture of the power-receiving-unit coordinate system (X₂, Y₂) in the world coordinate system on the basis of a posture of the power-transmitting-unit coordinate system (X₁, Y₁) in the world coordinate system, both the power-transmitting-unit and power-receiving-unit coordinate systems being illustrated in FIG. 3.

Furthermore, the parking intention estimation unit 222 calculates a relative velocity vector based on the relative positions of the power receiving unit 20 to the power transmitting unit 10, which have been recognized by the vehicle state recognition unit 210 on a time series basis (FIG. 2/STEP 206). Thus, a relative velocity vector V in the world coordinate system or the power-transmitting-unit coordinate system is obtained as denoted by a dotted-line arrow in FIG. 4. FIG. 4 illustrates a situation in which the vehicle 2 is moving backward toward a parking space PS where the power transmitting unit 10 is installed.

Whether the user or driver of the vehicle 2 intends to park the vehicle is determined based on the relative velocity vector V and a steering angle δ of the vehicle 2, the steering angle δ being recognized by the vehicle state recognition unit 210 (FIG. 2/STEP 208).

First, the relative velocity vector V is corrected to a relative velocity vector V(8) in accordance with the steering angle δ of the vehicle 2. For example, in accordance with a steering angle δ₁ of the vehicle 2 moving backward while curving to the left, the relative velocity vector V is corrected to a relative velocity vector V(δ₁) of which tip is deviated toward the left side of the vehicle 2 as indicated by a one-dot-chain line in FIG. 4. Furthermore, in accordance with a steering angle δ₂ of the vehicle 2 moving backward while curving to the right, the relative velocity vector V is corrected to a relative velocity vector V(δ₂) of which tip is deviated toward the right of the vehicle 2 as indicated by a two-dot-chain line in FIG. 4.

Then, whether the user of the vehicle 2 intends to park the vehicle into the parking space PS is estimated or determined depending on whether the relative velocity vector V(δ) after having been corrected in accordance with the steering angle δ of the vehicle 2 is oriented toward the parking space PS where the power transmitting unit 10 is installed. For example, because the relative velocity vector V(δ₁) after the correction is not oriented toward the parking space PS as illustrated in FIG. 4, it is determined in such a case that the user does not intend to park the vehicle. On the other hand, because the relative velocity vector V(δ₂) after the correction is oriented toward the parking space PS as illustrated in FIG. 4, it is determined in such a case that the user intends to park the vehicle.

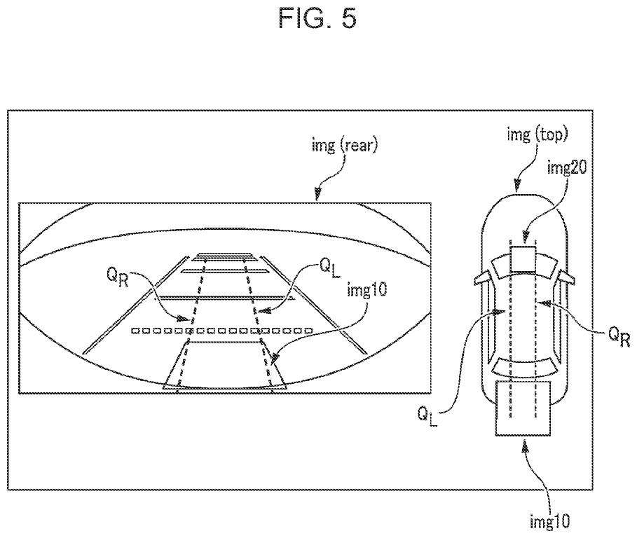

If it is determined that the user intends to park the vehicle (FIG. 2/STEP 208 . . . YES), the parking assistance unit 220 creates the parking assistance information representing the relative position after the correction (FIG. 2/STEP 210). For example, the parking assistance information is created so as to present a simulated top view img(top) of the vehicle 2 illustrated on the right side in FIG. 5, namely an image on which an image img20 representing the power receiving unit 20 is arranged at the relative position after the correction with respect to an image img10 representing the power transmitting unit 10.

In this embodiment, based on the detection result of the steering angle among the detection results for the vehicle 2 (see FIG. 2/STEP 202) having been recognized by the vehicle state recognition unit 210, the parking assistance information is created so as to present a top view img(top), as illustrated on the right side in FIG. 5, on which a pair of left and right line segments Q_{L} and Q_{R} extending from the image img20, which represents the power receiving unit 20, in a moving direction of the vehicle 2 depending on the steering angle are indicated in a superimposed manner. The number of the line segments may be one or three or more.

Furthermore, the parking assistance information is created so as to present a vehicle rear image img(rear) representing a situation on the rear side of the vehicle 2 as illustrated on the left side in FIG. 5, the vehicle rear image img(rear) being taken by a rear camera constituting the sensor group 24 and including the image img10 representing the power transmitting unit 10 at a position that is deviated from an actually-image-taken position through a distance corresponding to the correction of the relative position. In addition, the parking assistance information is created so as to present a vehicle rear image img(rear) in which the pair of left and right line segments Q_{L} and Q_{R} are displayed in a superimposed manner. Coordinate transform between the world coordinate system or the power-transmitting-unit coordinate system and a taken-image coordinate system is realized with a rotation matrix and a translation matrix each representing the relative position of the power receiving unit 20 to the power transmitting unit 10.

The parking assistance information is displayed by the on-board control device 22 on the image display device 2422 constituting the output interface 242 (FIG. 2/STEP 212). Thus, as illustrated in FIG. 5, the vehicle rear image img(rear) and the top view img(top) are displayed as the parking assistance information on the image display device 2422.

On the other hand, if it is determined that the user does not intend to park the vehicle (FIG. 2/STEP 208 . . . NO), a series of the above-mentioned processes are brought into an end and the processing subsequent to the recognition of the position of the vehicle 2 (FIG. 2/STEP 202) by the vehicle state recognition unit 210 is repeated during a period in which the communication between the non-contact charging system 1 and the vehicle 2 is established. Thus, in this case, the parking assistance information is not created by the parking assistance unit 220.

### Advantageous Effects

According to the above-described parking assistance system 200 in cooperation with the non-contact charging system 1, the relative velocity vector V is calculated which represents the time-dependent change of the relative position P of the power receiving unit 20 or of the vehicle 2 including the power receiving unit 20 to the power transmitting unit 10 set as a reference (FIG. 2/STEP 206, see FIG. 4). Whether the user of the vehicle 2 intends to park the vehicle into the parking space PS is determined depending on whether the relative velocity vector V after having been corrected in accordance with the steering angle δ of the vehicle 2 is oriented toward the parking space PS (FIG. 2/STEP 208, see FIG. 4). Since it is inferred that the intention of the user to park the vehicle into the parking space PS or not is more clearly reflected on the steering angle δ of the vehicle 2, the accuracy in estimating whether the user intends to park the vehicle can be improved.

The parking assistance information is displayed on the image display device 2422 in accordance with the estimation result that the user of the vehicle 2 intends to park the vehicle into the parking space PS (FIG. 2/STEP 208 . . . YES→ . . . →STEP 212, see FIG. 5). On the other hand, the parking assistance information is not displayed on the image display device 2422 in accordance with the estimation result that the user of the vehicle does not intend to park the vehicle into the parking space (see FIG. 2/STEP 208 . . . NO→END). As a result, the accuracy in estimating the intention of the user to park the vehicle can be improved, and the user of the vehicle 2 can be relieved from feeling annoyed by the parking assistance information that is selectively displayed or not on the image display device 2422 in accordance with the estimation result.

### Other Embodiments of Present Disclosure

In the above-described embodiment, the parking assistance system 200 is constituted by the on-board control device 22 mounted on the vehicle 2. In another embodiment, however, the parking assistance system 200 may be constituted by the charge control device 12 of the non-contact charging system 1. In that case, the vehicle states detected by the sensor group 24 on the vehicle 2 may be transmitted to the non-contact charging system 1 and, in accordance with the detected vehicle states, the relative position of the power receiving unit 20 to the power transmitting unit 10 and a relative position vector therebetween may be recognized by the parking assistance system in the charge control device 12 instead of in the vehicle 2.

In the above-described embodiment, whether the user of the vehicle 2 intends to park the vehicle is determined depending on whether the relative velocity vector V is oriented toward the parking space PS (see FIG. 4/the relative velocity vector V(δ₁) denoted by the one-dot-chain line arrow and the relative velocity vector V(δ₂) denoted by the two-dot-chain line arrow). In another embodiment, however, whether the user of the vehicle 2 intends to park the vehicle may be determined depending on whether an angle formed by the relative velocity vector V and the relative position vector P falls within a specified angle range such as 150° to 210° or 160° to 200°.

In the above-described embodiment, whether the user of the vehicle 2 intends to park the vehicle is determined based on the relative velocity vector V(δ) after having been corrected in accordance with the steering angle δ of the vehicle 2 (see FIG. 4/the relative velocity vector V(δ₁) denoted by the one-dot-chain line arrow and the relative velocity vector V(δ₂) denoted by the two-dot-chain line arrow). In another embodiment, however, whether the user of the vehicle 2 intends to park the vehicle may be determined based on the relative velocity vector V that has been obtained in accordance with the detection result of the relative position of the power receiving unit 20 to the power transmitting unit 10 (see FIG. 4/the relative velocity vector V denoted by the dotted-line arrow).

The parking assistance unit 220 may calculate the relative velocity vector V on condition that the relative position having been recognized by the vehicle state recognition unit 210 falls within a range in which the power transmitting unit 10 and the power receiving unit 20 are detectable through wireless communication.

It is inferred that the intention of the user to park the vehicle into the parking space PS or not is more clearly reflected on the relative velocity vector V when the vehicle 2 has come close to the parking space PS to such an extent that the power transmitting unit 10 and the power receiving unit 20 are positioned within the range in which both the units are detectable through wireless communication. Therefore, the accuracy in estimating whether the user intends to park the vehicle can be improved. Thus, the user can be relieved from feeling annoyed by the parking assistance information that is selectively displayed or not on the image display device 2422 in accordance with the estimation result. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A parking assistance system comprising:
a vehicle state recognition unit that recognizes a relative position of a power receiving unit mounted on a vehicle to a power transmitting unit that transmits electric power to the power receiving unit in a non-contact manner to charge a battery mounted on the vehicle; and
a parking assistance unit that displays, on an image display device on the vehicle, parking assistance information to assist parking of the vehicle in accordance with the relative position of the power receiving unit to the power transmitting unit,
wherein the parking assistance unit includes a parking intention estimation unit that calculates a relative velocity vector representing a time-dependent change of the relative position having been recognized by the vehicle state recognition unit, and that estimates, based on a direction of the relative velocity vector, whether a user of the vehicle intends to park the vehicle into a parking space where the power transmitting unit is installed, and
the parking assistance unit displays the parking assistance information on the image display device on condition of the parking intention estimation unit having determined that the user of the vehicle intends to park the vehicle.

2. The parking assistance system according to claim 1, wherein the parking intention estimation unit determines that the user of the vehicle intends to park the vehicle into the parking space, when the parking space where the power transmitting unit is installed is recognized and the relative velocity vector is oriented toward the parking space.

3. The parking assistance system according to claim 1, wherein the parking assistance unit calculates the relative velocity vector on condition that the relative position having been recognized by the vehicle state recognition unit falls within a range in which the power transmitting unit and the power receiving unit are detectable through wireless communication.

4. The parking assistance system according to claim 1, wherein the vehicle state recognition unit further recognizes a steering angle of the vehicle, and
the parking intention estimation unit calculates the relative velocity vector based on, in addition to the relative position having been recognized by the vehicle state recognition unit, the steering angle of the vehicle.

5. The parking assistance system according to claim 1, wherein the parking assistance unit does not display the parking assistance information on the image display device when the parking intention estimation unit determines that the user of the vehicle does not intend to park the vehicle.

6. The parking assistance system according to claim 2, wherein the parking intention estimation unit determines that the user of the vehicle does not intend to park the vehicle into the parking space, when the relative velocity vector is not oriented toward the parking space.

7. The parking assistance system according to claim 4, wherein the parking intention estimation unit calculates the relative velocity vector based on the relative position having been recognized by the vehicle state recognition unit, and corrects the calculated relative velocity vector by the steering angle of the vehicle.

8. A vehicle comprises the parking assistance system according to claim 1.

9. A mobile device comprises the parking assistance system according to claim 1.

10. A non-contact charging device comprises the parking assistance system according to claim 1 and the power transmitting unit according to claim 1.

11. A parking assistance method comprising steps of:
(i) recognizing, by a computer, a relative position of a power receiving unit mounted on a vehicle to a power transmitting unit that transmits electric power to the power receiving unit in a non-contact manner to charge a battery mounted on the vehicle; and
(ii) displaying, by a computer, on an image display device on the vehicle, parking assistance information to assist parking of the vehicle in accordance with the relative position of the power receiving unit to the power transmitting unit,
wherein the step (ii) comprises:
calculating a relative velocity vector representing a time-dependent change of the relative position having been recognized, and estimating, based on a direction of the relative velocity vector, whether a user of the vehicle intends to park the vehicle into a parking space where the power transmitting unit is installed, and
displaying the parking assistance information on the image display device on condition that it is determined that the user of the vehicle intends to park the vehicle.
